(19) United States
(12) Patent Application Publication
(10) Pub. No.: US 2005/0240501 A1
(43) Pub. Date: Oct. 27, 2005

(54) Global financial commodity bull/bear positioning device

(75) Inventor: Sheng-Yu Huang, Taipei (TW)

Correspondence Address: TROXELL LAW OFFICE PLLC, SUITE 1404, 5205 LEESBURG PIKE, FALLS CHURCH, VA, 22041, US

(73) Assignee: Liang-Jung Huang

(21) Appl. No.: 10/830,010

(22) Filed: Apr. 23, 2004

(51) Int. Cl. G06F 17/60

(52) U.S. Cl. 705/37

(57) ABSTRACT

A global financial commodity bull/bear positioning device includes a processing unit, an input unit, a display unit and a program unit, wherein the processing unit is in connection with he input unit and the display unit and the program unit is installed in the processing unit for display market disk on the display unit under the control of the processing unit. The market disk is composed of a disk base and rotating pieces. The disk base is comprised of a raising-up section and a lowering-down section both having circumference on which indexes are marked. Each rotating piece is movably arranged on a top face of the disk base and has a positioning section corresponding to the raising-up and lowering-down sections of the disk base to provide indication of bull/bear markets of different periods of time. The input unit functions to enter values of the indexes of different time periods. Thus the bull/bear market information of different time periods can be combined together and the rotating pieces are mounted on the disk base to allow for correctly handling of timing of selling/buying of financial commodities.

### FIELD OF THE INVENTION

The present invention generally relates to a global financial commodity bull/bear positioning device, and in particular to a device comprising a program unit installed in a processing unit for illustrating market disks on a display unit, a plurality of rotating pieces being movably arranged on the market disk and associated with different periods of time to be applicable to all kinds of technical indexes, an input unit allowing for user's input of values of the indexes of different time periods corresponding to each rotating piece whereby a positioning section of each rotating piece is movable within and between raising-up section and lowering-down section of the market disk to show indication of the bull/bear market, and the bull/bear market information of different time periods being combined together to allow for access and understanding of interaction between different time periods and thus allowing for access of publicly available information and reflecting current situation of market, and thus enabling correctly handling the trend of market and applicable to global stock market, foreign exchange market and futures.

### BACKGROUND OF THE INVENTION

Due to the development of communication, computer and network industries, all kinds of information can be easily accessed and obtained. Thus, in the investment market, a number of financial commodities are derived, including stock market, foreign exchange market and futures.

Technical analysis of the financial commodity is based on all kinds of indicators, such as KD indicator and RSI indicator. The KD indicator shows a raising-up trend when K number is greater than D number, otherwise it shows a lowering-down trend. In practice, K number and D number are shown in term of percentage so that the upper and lower bounds of K and D numbers in the range of indexes 13 are always between 0 and 100. In order to handle the overall trend, information regarding the change of K and D numbers in different time periods is needed, such as monthly curve, weekly curve, daily curve, hourly curve, half-hour curve, quarter-hour curve and five minute curve in order to allow an investor to determine the time point of buying and selling. Although such an analysis tool based on the indicators allows the investors to predict the trend of the market, yet heretofore, such indicators are independent of each other, not combined with each other, there is no way that the investors can view the change of market as a whole, so that such conventional analysis is not completely fit for the requirement of general investors.

### SUMMARY OF THE INVENTION

The, a primary objective of the present invention is to provide a global financial commodity bull/bear positioning device, comprising a program unit installed in a processing unit for illustrating market disks on a display unit, a plurality of rotating pieces being movably arranged on the market disk and associated with different periods of time to be applicable to all kinds of technical indexes, an input unit allowing for user's input of values of the indexes of different time periods corresponding to each rotating piece whereby a positioning section of each rotating piece is movable within and between raising-up section and lowering-down section of the market disk to show indication of the bull/bear market, and the bull/bear market information of different time periods being combined together to allow for access and understanding of interaction between different time periods and thus allowing for access of publicly available information and reflecting current situation of market.

Another object of the present invention is to display a multiplicity of market disks on the display unit by the program unit under the control of the processing unit so as to allow the investors to simultaneously operate on a number of different kinds of stocks, trends of weighted average index of stock market and other financial commodities, such as foreign exchange market, Morgan futures, Taiwan stock index future, Tokyo Nikkei index, Dow Jones Industry index.

To achieve the above objective, in accordance with the present invention, a global financial commodity bull/bear positioning device is provided, comprising a processing unit, an input unit, a display unit and a program unit, wherein the processing unit is in connection with he input unit and the display unit and the program unit is installed in the processing unit for display market disk on the display unit under the control of the processing unit. The market disk comprises a disk base and rotating pieces. The disk base is comprised of a raising-up section and a lowering-down section both having circumference on which indexes are marked. Each rotating piece is movably arranged on a top face of the disk base and has a positioning section corresponding to the raising-up and lowering-down sections of the disk base to provide indication of bull/bear markets of different periods of time. The input unit functions to enter values of the indexes of different time periods. Thus the bull/bear market information of different time periods can be combined together and the rotating pieces are mounted on the disk base to allow for correctly handling of timing of selling/buying of financial commodities.

### BRIEF DESCRIPTION OF THE DRAWINGS

The present invention will be apparent to those skilled in the art by reading the following description of a preferred embodiment thereof, with reference to the attached drawings, in which:

FIG. 1 is a block diagram of a global financial commodity bull/bear positioning device constructed in accordance with the present invention;

FIG. 2 a perspective view of the global financial commodity bull/bear positioning device of the present invention;

FIG. 3 shows a display of the global financial commodity bull/bear positioning device of the present invention;

FIGS. 4-7 are plots illustrating the operation of the global financial commodity bull/bear positioning device of the present invention;

FIG. 8 is a plot of the indexes of FIGS. 4-7; and

FIG. 9 is similar to FIG. 3 but showing another embodiment of the present invention.

### DETAILED DESCRIPTION OF THE PREFERRED EMBODIMENT

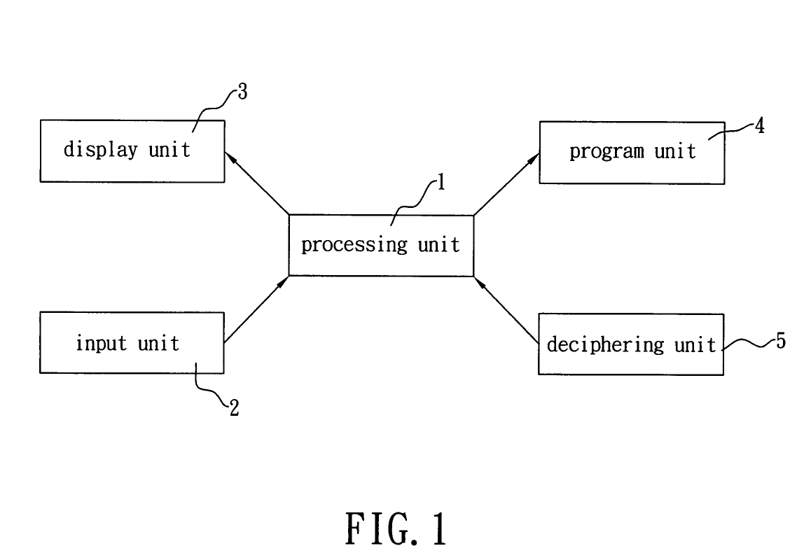

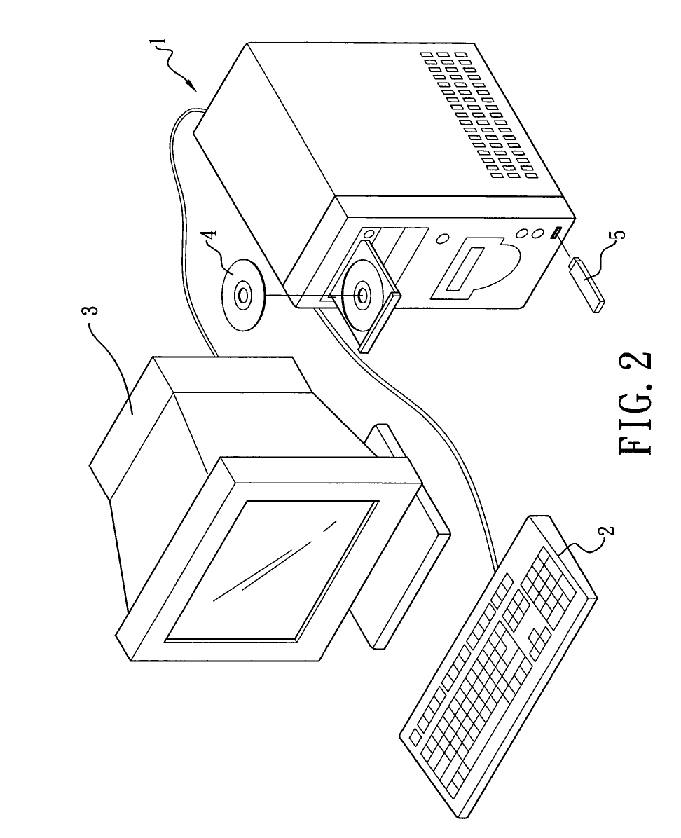

With reference to the drawings and in particular to FIGS. 1-3, a global financial commodity bull/bear positioning device in accordance with the present invention comprises a processing unit 1, an input unit 2, a display unit 3 and a program unit 4. The processing unit 1, such as a computer, is electrically connected to the input unit 2, such as a keyboard, and the display unit 3, such as a computer monitor. The program unit 4, such as an optic disk carrying program software or computer files of different forms, is installed in the processing unit 1 and is capable to illustrate one or more financial market disks 10 on the display unit 3. The financial market disk 10 is comprised of a disk base 11 and a plurality of rotating pieces 12, 13, 14, 15 movably arranged on the disk base 11. The disk base 11 is composed of a “raising-up” section 111, a “lowering-down” section 112, both of which has a circumference on which indexes 113 are marked. The rotating pieces 12, 13, 14, 15 are made as circular disks of different radii and are rotatably mounted to a top face of the disk base 11. Each rotating piece 12, 13, 14, 15 has a positioning section 121, 131, 141, 151 corresponding, respectively, to the raising-up section 111 and lowering-down section 112 of the disk base 11 for indication of bull/bear market of different periods of time. The input unit 112 allows for entering values of the indexes 113. Thus, the bull/bear market information of different time periods are combined and corresponding thereto, the rotating pieces 12, 13, 14, 15 are rotatably mounted on the disk base 11 for indicating of proper timing for buying/selling financial commodity.

A global financial commodity bull/bear positioning device is thus formed with the above discussed components of which the features reside on that the global financial commodity bull/bear positioning device is comprised of the program unit 4 that is installed in the processing unit 1 to allow for display of the financial market disks 10 on the display unit 3 under the control of the processing unit 1, further comprising rotating pieces 12, 13, 14, 15 that respectively represent information of different time periods so as to be suitable for all kinds of technical indicators, such as KD indicator and RSI indicator, and further comprising the input unit 2 that allows for entering values of the indexes 113 to correspond to the rotating pieces 12, 13, 14, 15, making the positioning sections 121, 131, 141, 151 of the rotating pieces 12, 13, 14, 15 rotating among the indexes 113 of the raising-up section 111 and the lowering-down section 112 of the disk base 11 so as to form indication of bull/bear market for different periods of information. Thus, bull/bear market information of different time periods are combined together to allow for understanding of interaction among bull/bear market information of different time periods, to completely handle the timing of buying/selling, making the present invention featured with easy and fast operation, easy access of available information for reflecting the actual market situation and awareness of trends of market, which enhances the practicability and convenience of the global financial commodity bull/bear positioning device of the present invention.

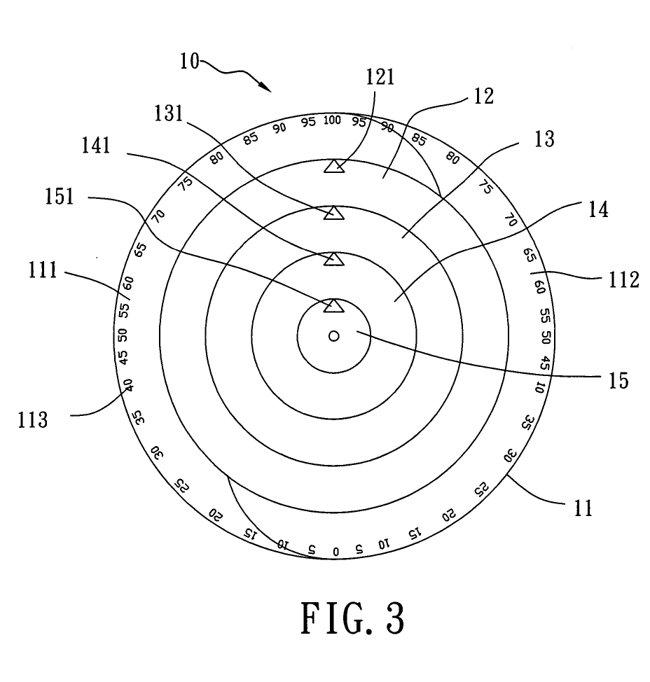

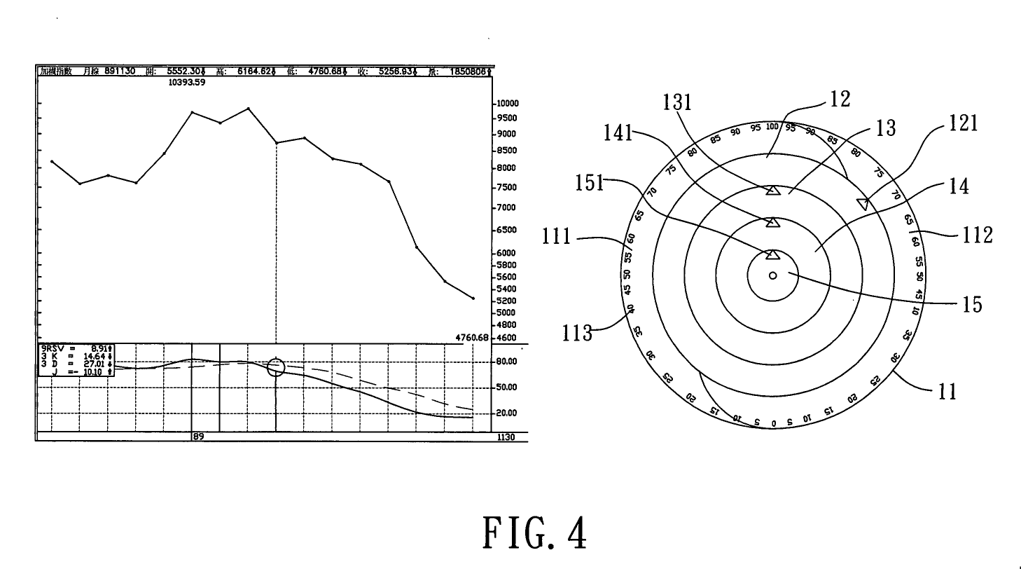

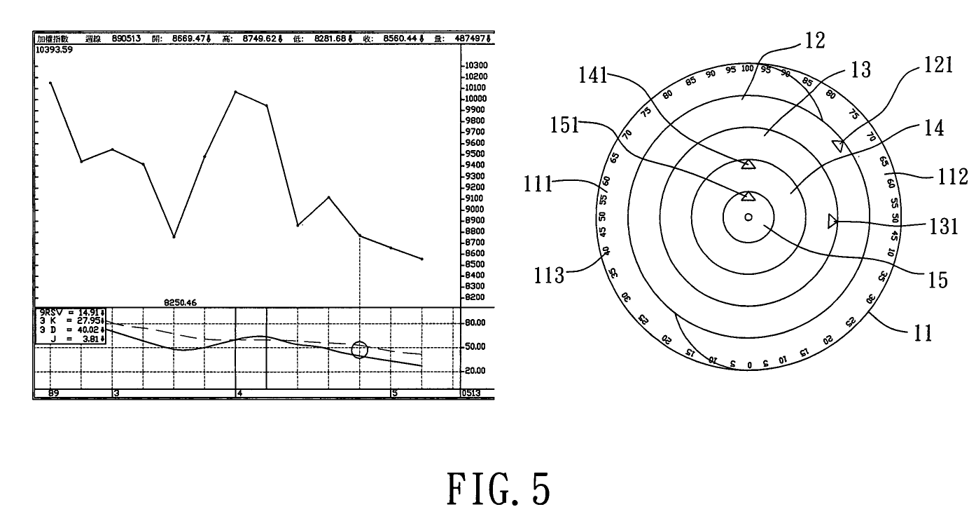

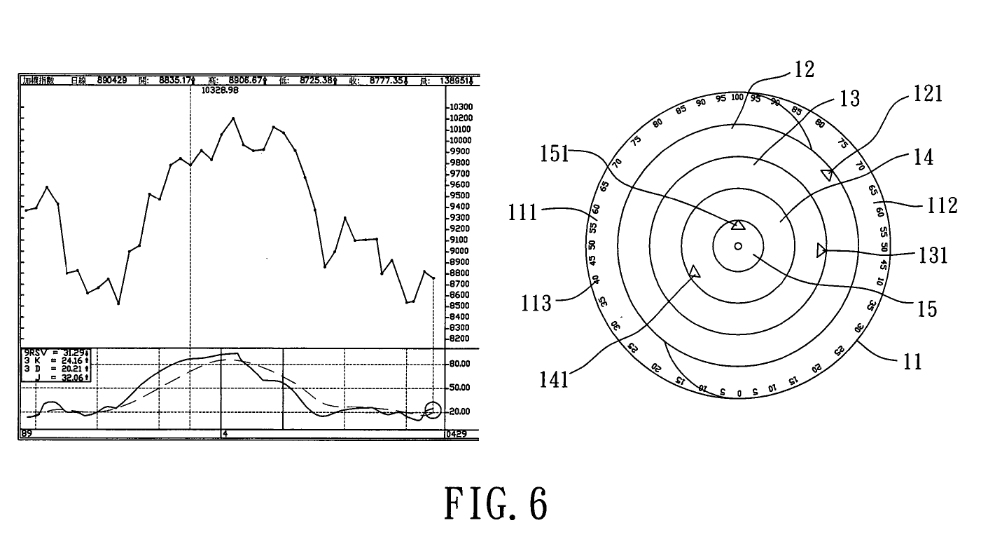

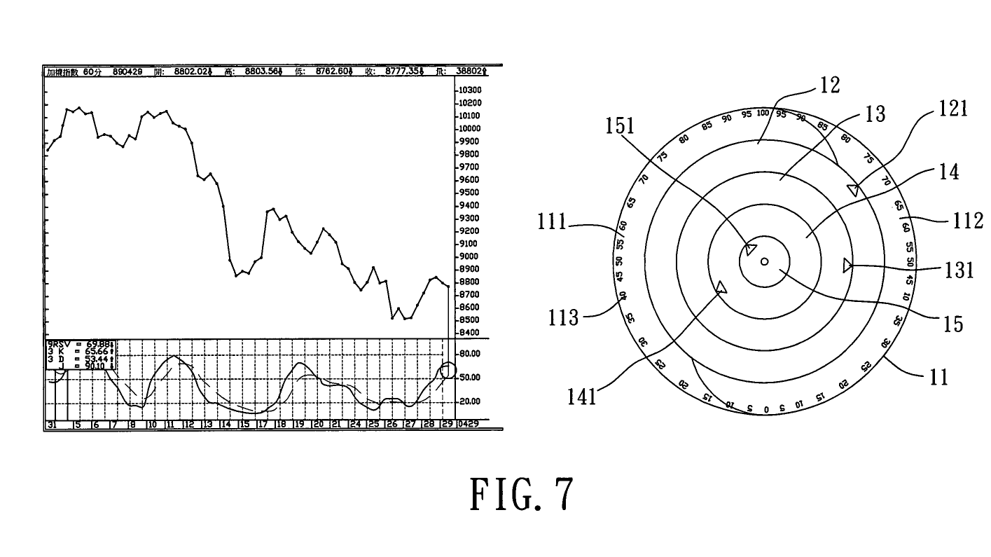

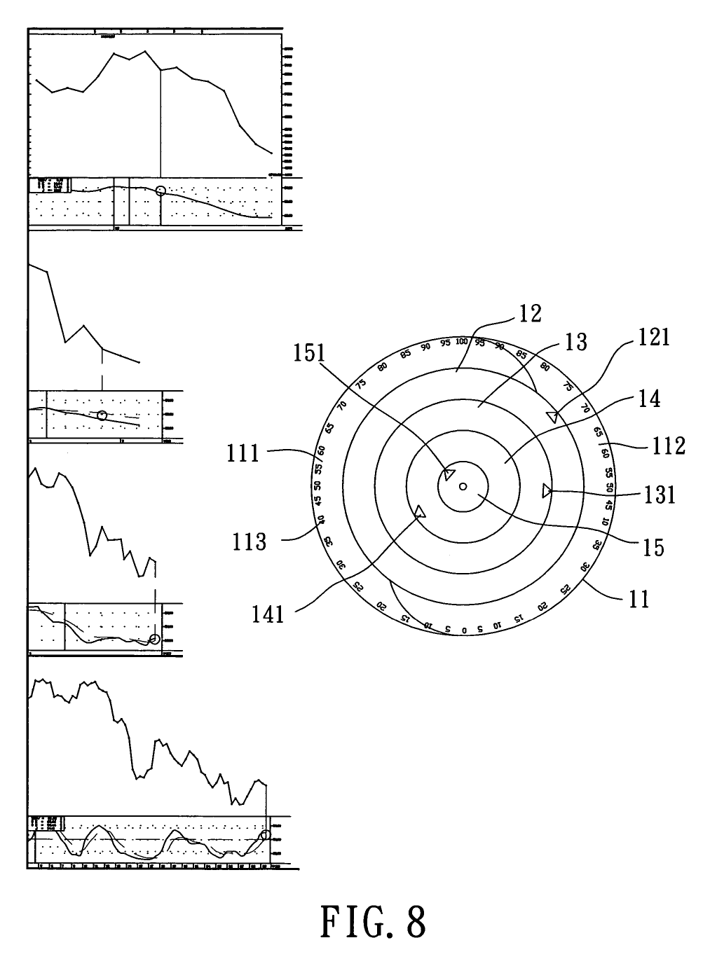

Also referring to FIGS. 3-8, in use, indexes 113 are marked on the corresponding raising-up section 111 and lowering-down section 112 of the disk base 11, which in the embodiment is KD indicator. Due to the fact that K and D numbers of the KD indicator are shown with percentage, the upper and lower bounds of K and D numbers of the indexes 113 are always between 0-100. If RSI indicator is taken, then the RSI value of the indexes 113 also have upper and lower bounds between 0-100. Taking weighted average index of Taiwan stock market of April 2000 as an example, see FIG. 3, the positioning sections 121, 131, 141, 151 of the rotating pieces 12, 13, 14, 15 that represent different periods of time are rotated to K number of the same time point. Referring to FIG. 4, K number of the monthly curve of April 2000 is 72.72 that is smaller than D number that is 75.99. This is a trend of lowering down. Thus, the positioning section 121 of the rotating piece 12 that represents the monthly curve is rotated to the index 113 having the value 72.72 within the lowering-down section 112 of the disk base 11. Referring to FIG. 5, K number of the weighted average weekly curve is 41.95 that is smaller than D number that is 51.85. This is a trend of lowering down. Thus, the positioning section 131 of the rotating piece 13 that represents the weekly curve is rotated to the index 113 having the value of 41.95 within the lowering-down section 112 of the disk base 11. Referring to FIG. 6, K number of the last day of the weighted average daily curve of April 2000 is 24.16 that is greater than D number that is 20.21. This is a trend of rising up. Thus, the positioning section 141 of the rotating piece 14 that represents the daily curve is rotated to the index 113 having the value 24.16 within the raising-up section 111 of the disk base 11. Referring to FIG. 7, K number of the last hour of the weighted average hourly curve for April 2000 is 65.66 that is greater than D number that is 53.44. This is a trend of raising up. Thus, the positioning section 151 of the rotating piece 15 that represents the hourly curve is rotated to the index 113 having the value of 65.66 within the raising-up section 111 of the disk base 11. With the aid of the positioning sections 121, 131, 141, 151 of the rotating pieces 12, 13, 14, 15 that respectively represent monthly, weekly, daily and hourly curves, based on the location of the positioning sections 121, 131, 141, 151 within the raising-up section 111 and the lowering-down section 112 and the change thereof and direction of moving, it is easy to access the information available publicly and completely handle the trend of the markets. Referring to FIG. 8, the number of the positioning sections 121, 131 of the rotating pieces 12, 13 that represent respectively the monthly curve and weekly curve within the lowering-down section 112 is the same as that of the positioning sections 141, 151 of the rotating pieces 14, 15 that represent respectively the daily curve and hourly curve within the raising-up section 111. However, the rotating pieces 12, 13 that represent the monthly curve and the weekly curve are far greater than the rotating pieces 14, 15 that represent the daily curve and the hourly curve. Thus, it is quite apparent that the weighted average index of the stock market of that date is of a trend of lowering down.

Referring to FIG. 6, the daily curve of April 2000 turns over from the high point of the raising-up section 111 toward the lowering-down section 112 and runs all the way down to the bottom of the lowering-down section 112 of April until it slightly rebounds to the raising-up section 111. Although there is still space for raising up, the weekly curve of the higher order that is initially located in the raising-up section 11 at the beginning of April falls into the lowering-down section 112 and maintains within the lowering-down section 112 for the remaining of April. This concludes the lowering-down trend. Further, the weighted average index monthly curves of January to April 2000, see FIG. 4, reveals that the trend of the monthly curve turns over from the high point of raising-up section 111 to the lowering-down section 112 and continuously going down in April, showing an overall lowering down trend. Thus, with the aid of the change of the positioning sections 121, 131 of the rotating pieces 12, 13 that represent the monthly and weekly curves within and between the raising-up section 111 and the lowering-down section 112, the trend of raising-up/lowering-down can be completely predicted/handled. To get further aware of the trend of raising-up/lowering-down, the change and location of the positioning sections 141, 151 of the rotating pieces 14, 15 that represent the daily and hourly curves can be further taken into consideration. If desired, other rotating pieces, such as those representing half-hour curve, quarter-hour curve and 5-minute curve, can be further taken into consideration.

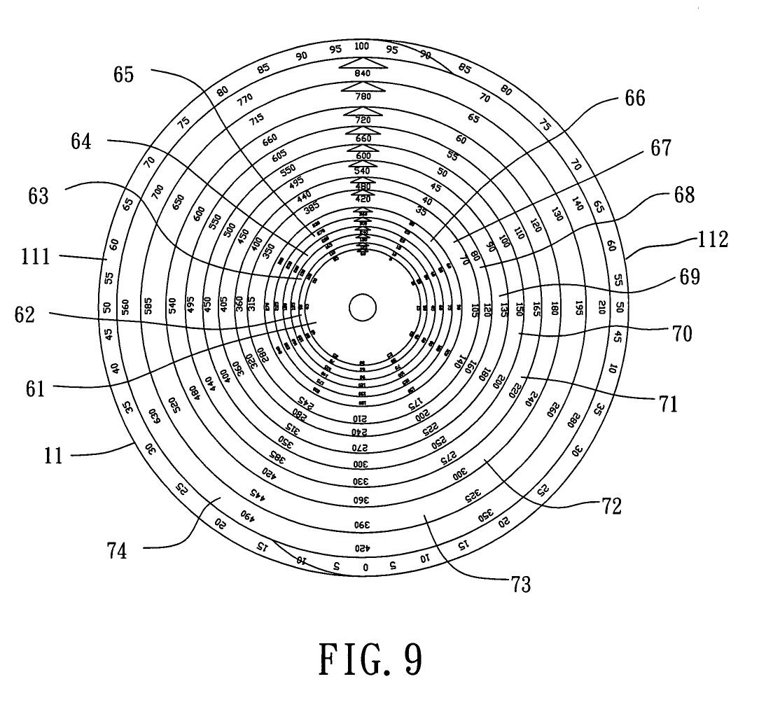

Referring to FIG. 9, in use, a plurality of rotating pieces 61-74 is arranged on the top face of the disk base 11. The rotating pieces 61-74 can be grouped as a number of sets, such as the rotating pieces 61-64 forming a first set, the rotating pieces 65-68 forming a second set and so on. The rotating pieces 61-74 can be grouped in different ways, such as the rotating pieces 61-67 grouped as the first set, while the rotating pieces 68-74 grouped as the second set. This allows the disk base 11 to simultaneously operate on several particular stocks and a number of disk bases 11 can be displayed, either selectively or if desired, simultaneously, on the display unit 3 by the program unit 4 under the control of the processing unit 1. Thus, a user may simultaneously operate a number of stocks or predict the trends, wherein one of the disk bases is used as reference to explain the market situation.

Besides moving the rotating pieces within and between the raising-up section 111 and the lowering-down section 112 of the disk base 11 to indicate the bull/bear markets for accessing public information that reflect the current situation of the market and allowing for handling of the trend of the weighted average index of the stock market, the present invention can also be employed to analyze any particular one of the stocks that are sold in the market to help determining the selling point. IN addition, the present invention may also be employed to the analysis of other financial commodities, such as foreign exchange market and futures and can be used for global financial commodities, such as futures of Taiwan index, Tokyo Nikkei index, Dow Jones Industry index and Morgan Futures.

Further, for security purposes, the program unit 4 can be protected with secret code, such as enciphering. Thus, a deciphering unit 5 is added, connected to the processing unit 1 for driving the enciphered program unit 4. With such a deciphering operation, the input unit 2 may be operable for entering indexes 113 of different periods to illustrate the market disks 10 on the display unit 3 and the rotating pieces 12, 13, 14, 15 can then be operable to show the related information.

Although the present invention has been described with reference to the preferred embodiment thereof, it is apparent to those skilled in the art that a variety of modifications and changes may be made without departing from the scope of the present invention which is intended to be defined by the appended claims.

1. A global financial commodity bull/bear positioning device, comprising a processing unit, an input unit, a display unit and a program unit, wherein the processing unit is in connection with he input unit and the display unit, the program unit is installed in the processing unit for display market disk on the display unit under the control of the processing unit, the market disk comprising a disk base and rotating pieces, the disk base being comprised of a raising-up section and a lowering-down section both having circumference on which indexes are marked, each rotating piece being movably mounted to a top face of the disk base and having a positioning section corresponding to the raising-up and lowering-down sections of the disk base to provide indication of bull/bear markets of different period of time, the input unit entering values of the indexes of different time period, whereby the bull/bear market information of different time periods can be combined together and the rotating pieces are mounted on the disk base to allow for correctly handling of timing of selling/buying of financial commodities.

2. The global financial commodity bull/bear positioning device as claimed in claim 1, wherein the rotating pieces each comprise a circular disk of different radius movably mounted on the top face of the disk base.

3. The global financial commodity bull/bear positioning device as claimed in claim 1, wherein the indexes of the disk base comprise K and D numbers of KD indicator.

4. The global financial commodity bull/bear positioning device as claimed in claim 1, wherein the indexes of the disk base comprises RSI number of RSI indicator.
